(19) United States
(12) Patent Application Publication
(10) Pub. No.: US 2026/0093038 A1
(43) Pub. Date: Apr. 2, 2026

(54) ON-VEHICLE DEVICE

(71) Applicant: DENSO CORPORATION, Kariya-city (JP)

(72) Inventors: Yu KOYAMA, Nisshin-city (JP); Hirotaka KOYAMA, Kariya-city (JP); Ryoma NIIHARA, Kariya-city (JP); Yoshihiro HIROHASHI, Kariya-city (JP); Yukimasa TAMATSU, Kariya-city (JP)

(21) Appl. No.: 19/413,893

(22) Filed: Dec. 9, 2025

Related U.S. Application Data
(63) Continuation of application No. PCT/JP2024/018761, filed on May 22, 2024.

(30) Foreign Application Priority Data
Jun. 12, 2023 (JP) 2023-096458

(51) Int. Cl. G01S 17/86; G01S 7/481

(52) U.S. Cl. CPC G01S 17/86; G01S 7/4813

(57) ABSTRACT

An on-vehicle device is to be disposed on a vehicle, and includes an electromagnetic element and an acoustic sensor. The electromagnetic element performs at least one of radiation of electromagnetic wave to an outside of the on-vehicle device or detection of electromagnetic wave from the outside of the on-vehicle device. The acoustic sensor detects acoustics generated in the outside of the on-vehicle device. The acoustic sensor is integrated with the electromagnetic element.

### CROSS REFERENCE TO RELATED APPLICATION

The present application is a continuation application of International Patent Application No. PCT/JP2024/018761 filed on May 22, 2024, which designated the U.S. and claims the benefit of priority from Japanese Patent Application No. 2023-096458 filed on Jun. 12, 2023. The entire disclosures of all the above applications are incorporated herein by reference.

### TECHNICAL FIELD

The disclosure of this specification relates to a technology for detecting acoustics in a vehicle.

### BACKGROUND ART

There is a roof module for a vehicle equipped with an environmental sensor that senses a vehicle environment.

### SUMMARY

One aspect disclosed herein is an on-vehicle device configured to be mounted in a vehicle. The on-vehicle device includes an electromagnetic element and an acoustic sensor. The electromagnetic element is configured to perform at least one of radiation of electromagnetic wave to an outside of the on-vehicle device and detection of electromagnetic wave from the outside of the on-vehicle device. The acoustic sensor is configured to detect acoustics generated in the outside of the on-vehicle device. The acoustic sensor may be integrated with the electromagnetic element.

### BRIEF DESCRIPTION OF DRAWINGS

FIG. 1 is a diagram illustrating an example of positions where an on-vehicle device of the present disclosure can be installed.

FIG. 2 is a diagram schematically showing the configuration of the on-vehicle device.

FIG. 3 is a cross-sectional view of an example of the on-vehicle device.

FIG. 4 is a cross-sectional view of an example of the on-vehicle device.

FIG. 5 is a diagram illustrating a method for mounting the on-vehicle device of FIG. 4 to a vehicle.

FIG. 6 is a diagram illustrating the method for mounting the on-vehicle device of FIG. 4 to a vehicle.

FIG. 7 is a diagram illustrating the method for mounting the on-vehicle device of FIG. 4 to a vehicle.

FIG. 8 is a diagram illustrating communication between the on-vehicle device and an ECU.

FIG. 9 is a cross-sectional view showing an example of the on-vehicle device.

FIG. 10 is a cross-sectional view showing an example of the on-vehicle device.

FIG. 11 is a cross-sectional view showing an example of the on-vehicle device.

FIG. 12 is a cross-sectional view showing an example of the on-vehicle device.

FIG. 13 is a diagram illustrating a method for mounting the on-vehicle device of FIG. 12 to a vehicle.

FIG. 14 is a diagram illustrating the method for mounting the on-vehicle device of FIG. 12 to a vehicle.

FIG. 15 is a diagram illustrating the method for mounting the on-vehicle device of FIG. 12 to a vehicle.

FIG. 16 is a cross-sectional view showing an example of the on-vehicle device.

FIG. 17 is a diagram illustrating a method for mounting the on-vehicle device of FIG. 16 to a vehicle.

FIG. 18 is a diagram illustrating the method for mounting the on-vehicle device of FIG. 16 to a vehicle.

FIG. 19 is a diagram illustrating the method for mounting the on-vehicle device of FIG. 16 to a vehicle.

FIG. 20 is a cross-sectional view showing a retainer spring.

FIG. 21 is a cross-sectional view showing a retainer spring.

FIG. 22 is a cross-sectional view showing an example of the on-vehicle device.

FIG. 23 is a cross-sectional view showing an example of the on-vehicle device.

FIG. 24 is a cross-sectional view showing an example of the on-vehicle device.

FIG. 25 is a cross-sectional view showing an example of the on-vehicle device.

FIG. 26 is a cross-sectional view showing an example of the on-vehicle device.

FIG. 27 is a cross-sectional view showing an example of the on-vehicle device.

FIG. 28 is a cross-sectional view showing an example of the on-vehicle device.

FIG. 29 is a cross-sectional view showing an example of the on-vehicle device.

FIG. 30 is a cross-sectional view showing an example of the on-vehicle device.

### DESCRIPTION OF EMBODIMENTS

To being with, examples of relevant techniques will be described.

There is a roof module for a vehicle equipped with an environmental sensor that senses a vehicle environment. Examples of environmental sensors include optical sensors such as cameras, radar, and LiDAR (Light Detection and Ranging/Laser Imaging Detection and Ranging).

The inventors of the present disclosure have conceived of additionally mounting an acoustic sensor for detecting acoustics in the vehicle, in addition to electromagnetic elements such as optical sensors. However, since many other elements are also mounted in the vehicle, securing installation space for the acoustic sensor and suppressing the increase in assembly work required to mount the acoustic sensor to the vehicle have become issues.

The present disclosure provides an on-vehicle device suitable for installation in a vehicle.

One aspect disclosed herein is an on-vehicle device configured to be mounted in a vehicle. The on-vehicle device includes an electromagnetic element and an acoustic sensor. The electromagnetic element is configured to perform at least one of radiation of electromagnetic wave to an outside of the on-vehicle device and detection of electromagnetic wave from the outside of the on-vehicle device. The acoustic sensor is configured to detect acoustics generated in the outside of the on-vehicle device. The acoustic sensor is integrated with the electromagnetic element.

According to the on-vehicle device described above, the electromagnetic element and the acoustic sensor are integrated with each other. Thus, securing installation space for the acoustic sensor in the vehicle becomes easier, and it is possible to suppress an increase in the number of person-hours required to install the acoustic sensor in the vehicle. Accordingly, it is possible to provide an on-vehicle device suitable for installation in a vehicle.

Hereinafter, various embodiments will be described with reference to the drawings. It should be noted that, in the following embodiments, corresponding components are denoted by the same reference numerals, and redundant descriptions may be omitted. In cases where only a part of the configuration is described in each embodiment, the configurations of other portions previously described in other embodiments may be applied to those parts. Furthermore, in the descriptions of each embodiment, not only the explicitly stated combinations of configurations but also, unless there is a particular hindrance to such combinations, configurations from multiple embodiments may be partially combined with each other even if not explicitly mentioned.

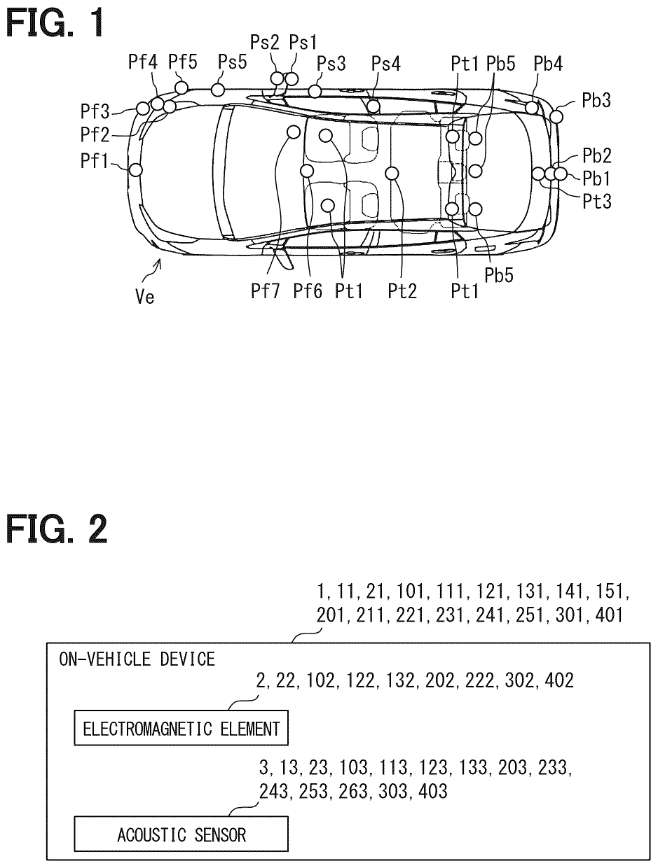

(Schematic Configuration of the On-Vehicle Device) A on-vehicle device according to the present disclosure is configured to be installed in a vehicle Ve, as shown in FIG. 1. As shown in FIG. 2, the on-vehicle device has a structure in which an electromagnetic element and an acoustic sensor are integrated with each other.

The electromagnetic element performs at least one of emitting electromagnetic waves toward an outside of the on-vehicle device and detecting electromagnetic waves from the outside. The electromagnetic waves referred to herein may be electromagnetic waves of any wavelength, such as radio waves, microwaves, infrared rays, visible light, or ultraviolet rays. Examples of the electromagnetic element include a camera, millimeter wave radar, LiDAR, lighting device, communication device, rain sensor, and illuminance sensor.

The camera is a sensor that detects electromagnetic waves from outside the on-vehicle device. The electromagnetic waves handled by the camera may be visible light or near-infrared light. The camera may be a camera for an autonomous driving or driving assistance that is installed facing outward of the vehicle Ve, captures the surrounding environment of the vehicle, and detects dynamic objects such as vehicles and pedestrians in the surrounding environment, as well as static objects such as buildings and objects in the surrounding environment. The camera may be used in applications such as parking assistance, where the camera cooperates with another on-vehicle camera to generate and present a composite image that provides the driver with a bird's-eye view of the vehicle Ve. The camera may also be used in a face recognition of the driver who attempts to board the vehicle.

The millimeter wave radar is a sensor that performs both emission of electromagnetic waves directed outside the on-vehicle device and detection of electromagnetic waves from the outside. The electromagnetic waves handled by the millimeter wave radar may be millimeter waves. The millimeter wave radar is used for autonomous driving or driving assistance. The millimeter wave radar transmits probing waves toward the outside of the vehicle Ve and receives reflected waves that are reflected by dynamic or static objects present in the surrounding environment.

LiDAR is a sensor that performs both emission of electromagnetic waves directed outside the on-vehicle device and detection of electromagnetic waves from the outside. The electromagnetic waves handled by LiDAR are laser light such as near-infrared light. LiDAR is used for autonomous driving or driving assistance. LiDAR emits pulsed laser light toward the outside of the vehicle Ve and detects reflected light that has reflected by dynamic or static objects present in the surrounding environment. The distance from the LiDAR to an object is measured by utilizing the time of flight (ToF) of the laser light. LiDAR may be configured to detect the three-dimensional shape of an object by scanning the emitted laser light.

The lighting device emits electromagnetic waves toward the outside of the on-vehicle device. The electromagnetic waves handled by the lighting device are visible light. The lighting device is used for signaling to the outside of the vehicle. The lighting device includes a low beam headlamp, a high beam headlamp, turn indicators, and hazard lamps. The communication device transmits and receives radio waves as electromagnetic waves in accordance with a predetermined communication standard. The rain sensor is a sensor that detects raindrops adhering to the windshield or the like by emitting light and detecting the reflected or refracted light caused by the raindrops with a light-receiving element. The illuminance sensor is a sensor that detects external light such as sunlight incident on the vehicle Ve, and is equipped with a light-receiving element capable of measuring the illuminance of the external light.

The acoustic sensor detects acoustics generated outside the on-vehicle device. The cause of acoustic generation may be the same with or completely different from an object to be detected by the electromagnetic element. The detected acoustics may be sound (i.e., air vibrations) arriving from outside the on-vehicle device, or vibrations of the on-vehicle device generated by the sound. The sound arriving from outside the on-vehicle device may be a siren emitted by an emergency vehicle such as a police car, fire engine, or ambulance in the external environment of the vehicle Ve. The sound arriving from outside the on-vehicle device may be road noise generated between the vehicle Ve and the road. The sound arriving from outside the on-vehicle device may also be engine noise, electric motor noise, or the like inside the vehicle Ve.

The on-vehicle device can be applied to various installation positions in the vehicle Ve. The on-vehicle device can be installed on the inner side of the front, sides, rear, or top surface of the vehicle. The vehicle Ve has an external structure having a plate-shaped portion. The plate shaped portion has both a smooth curved surface and a flat surface for design aesthetics and aerodynamic characteristics.

The on-vehicle device is supported by a portion of the external structure that is exposed to the outside of the vehicle Ve, such as a plate shaped portion. Specifically, the on-vehicle device is held at a portion of the external structure that is suitable for installing the electromagnetic element. As shown in FIG. 1, the external structure on the front surface of the vehicle include, for example, a front emblem Pf1, a headlamp cover Pf2, a front fog lamp cover Pf3, a bumper corner Pf4, a bumper side Pf5, a front camera cover Pf6, and a windshield Pf7. The external structure on the side surfaces of the vehicle include, for example, a side mirror surface Ps1, a side mirror cover Ps2, a door Ps3, each pillar (such as a B-pillar Ps4), and a side fender Ps5. The external structure Es on the rear surface of the vehicle include, for example, a back camera cover Pb1, a rear viewing window Pb2, a reflector cover Pb3, a tail lamp module cover Pb4, and a rear window edge Pb5.

The plate-shaped portions such as the covers of the external structure vibrates when the plate-shaped portions receive sound coming from the external environment of the vehicle Ve. In addition, vibrations transmitted from the road surface or vibrations generated when the vehicle Ve collides are propagated within the external structure, causing the plate-shaped portions to vibrate. In addition, vibrations caused by the road surface or generated when the vehicle Ve collides are transmitted to the plate-shaped portions, causing the plate-shaped portions to vibrate. The acoustic sensor can indirectly detect acoustics by measuring the vibration and/or the sound re-radiated by the vibration.

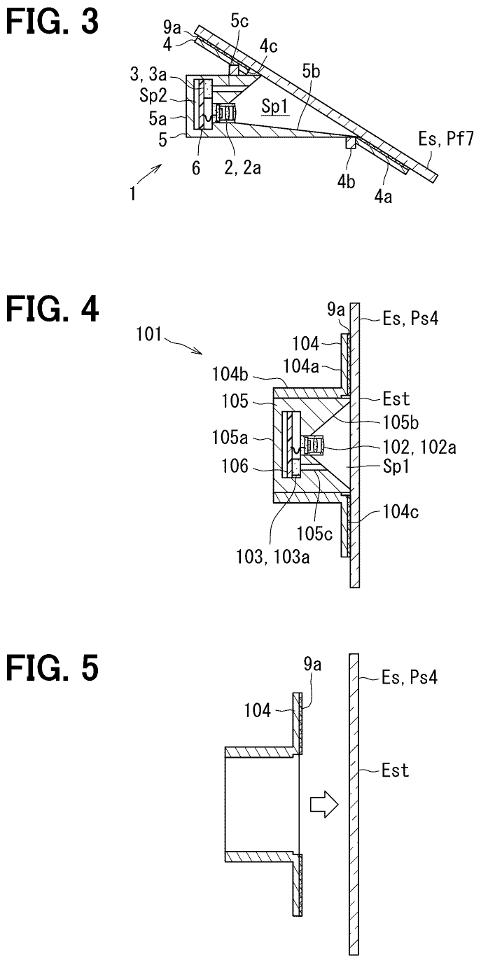

(First Embodiment) As shown in FIGS. 3 and 4, in the on-vehicle device 1 of a first embodiment, a camera 2a serving as the electromagnetic element 2 and an acoustic sensor 3 are integrated with each other.

In the example of FIG. 3, the on-vehicle device 1 is mounted on the windshield Pf7, which serves as the external structure Es, from the interior side of the vehicle cabin. The windshield Pf7 is formed, for example, in a curved plate shape with light-transmitting properties. The windshield Pf7 is arranged at an incline such that the distance between the windshield Pf7 and the ground on which the vehicle Ve is situated increases gradually from the front toward the rear of the vehicle Ve. The on-vehicle device 1 includes components such as a bracket 4, a housing 5, a circuit board 6, the camera 2a, and the acoustic sensor 3.

The bracket 4 is a member for attaching the housing 5 to the vehicle Ve. The bracket 4 is formed of metal, such as steel (plated or electrodeposition coated), aluminum, or the like. The bracket 4 includes a mounting portion 4a, a housing holding portion 4b, and an opening 4c.

The mounting portion 4a has a plate-like shape along the shape of the windshield Pf7. The mounting portion 4a is held on the windshield Pf7 via an adhesive 9a that is applied to substantially the entire surface of the mounting portion 4a that faces the windshield Pf7 in a layered manner. The housing holding portion 4b is provided on the side of the mounting portion 4a opposite to the windshield Pf7, and holds the housing 5, for example, by engagement or fastening. The opening 4c is an opening in the center of the mounting portion 4a. The opening 4c allows light from the external environment of the vehicle Ve to enter the camera 2a through the windshield Pf7.

The housing 5 is fixed to the windshield Pf7 via the bracket 4. The housing 5 is commonly provided for the camera 2a and the acoustic sensor 3. The housing 5 is formed of a metal such as aluminum. The housing 5 includes a board housing portion 5a, a hood 5b, and a sound guiding hole 5c. The board housing portion 5a is disposed on the side of the camera 2a opposite to the windshield Pf7. The board housing portion 5a defines a housing space Sp2 for housing the circuit board 6.

The hood 5b defines a light-shielding space Sp1 between the camera 2a and the windshield Pf7. The light-shielding space Sp1 has a tapered shape corresponding to the angle of view of the camera 2a. Specifically, the width of the light-shielding space Sp1 increases in a direction away from the camera 2a and toward the windshield Pf7. The hood 5b blocks diffusely reflected light that would degrade the image quality captured by the camera 2a, out of the light incident from the external environment. The surface of the hood 5b facing the space may be in a dark color to absorb the diffusely reflected light.

In the example shown in FIG. 3, the hood 5b includes an upper hood and a lower hood, and has an asymmetric shape corresponding to the inclined shape of the windshield Pf7. The taper angle of the upper hood is set to be larger than the taper angle of the lower hood. Here, the taper angle is defined as an angle of the surface of the hood 5b with respect to the optical axis of the camera 2a.

The sound guiding hole 5c is a hole that fluidly connects between the housing space Sp2 of the circuit board 6 and the light-shielding space Sp1 formed by the hood 5b. The sound guiding hole 5c is, for example, an elongated tubular hole having a circular cross-section that straightly extends. The sound guiding hole 5c guides the sound from the light-shielding space Sp1 to the housing space Sp2, where a microphone 3a, which will be described later, is installed. Here, in order to further enhance the acoustic detection performance, it is preferable that the end of the sound guiding hole 5c closer to the housing space Sp2 is formed at a position facing the microphone 3a mounted on the circuit board 6. In order to further enhance the performance of acoustic detection, it is preferable that the end of the sound guiding hole 5c on the light-shielding space Sp1 is disposed at a position in the hood 5b between the camera 2a (more specifically, the camera unit) and an intermediate point between the camera 2a and the windshield Pf7.

The circuit board 6 is formed, for example, into a flat plate shape from a synthetic resin such as glass epoxy resin. The circuit board 6 is fixed to the housing 5, for example, by engagement or fastening. The circuit board 6 is shared by the camera 2a and the acoustic sensor 3. The circuit board 6 mounts a control circuit for the camera 2a. The circuit board 6 also mounts the microphone 3a and a control circuit for the acoustic sensor 3. Both control circuits are mounted on the circuit board 6 in a configuration in which a connector for electrical connection to the vehicle Ve is shared with each other.

The camera 2a includes the camera unit and the control circuit. The camera unit is integrally formed such that an image sensor and lens system are housed within a lens barrel. The camera unit is disposed at the tip end of the tapered light-shielding space Sp1.

The image sensor is disposed on the side of the lens system opposite to the windshield Pf7. The image sensor is, for example, a CCD or CMOS, and is electrically connected to the control circuit mounted on the circuit board 6 via a flexible cable. The detection signals acquired by the image sensor are sequentially transmitted to the control circuit. The control circuit generates image data. The lens system includes one or more lenses. The lens system collects light that enters through the windshield Pf7 and the light-shielding space Sp1, and forms an image on the image sensor.

The acoustic sensor 3 includes the microphone 3a and the control circuit. The microphone 3a is mounted on the circuit board 6 with facing the sound guiding hole 5c. The microphone is, for example, a condenser microphone, and in the present embodiment, a MEMS microphone 3a. MEMS stands for Micro Electro Mechanical Systems.

The MEMS microphone 3a is a microphone element that converts air vibrations into electrical signals. The MEMS microphone 3a outputs, as an analog electrical signal, changes in capacitance generated by vibration of a thin diaphragm (membrane) in response to sound pressure. The MEMS microphone 3a receives sound reflected in the light-shielding space Sp1 through the sound guiding hole 5c and detects the sound. The shape of the hood 5b for blocking diffusely reflected light, that is a horn-like structure of the hood 5b increases the sound pressure. Thus, the MEMS microphone 3a can detect the sound with the increased sound pressure. The analog electrical signal from the MEMS microphone 3a is converted into a digital sound signal by the control circuit.

FIG. 4 shows an on-vehicle device 101 that is different from that shown in FIG. 3 at a point that the on-vehicle device 101 is attached to the B-pillar Ps4 as the external structure Es. The cover of the B-pillar Ps4 that is exposed to the external environment is formed in a plate shape with a light-transmitting plate section Est that allows light to pass through, so that light can be incident on the camera 2a via the light-shielding space Sp1. The light-transmitting plate section Est extends approximately vertically with respect to the ground. Portions of the B-pillar Ps4 other than the light-transmitting plate section Est may be formed in a dark color with opacity.

In this example, the bracket 104 has a mounting portion 104a and an opening 104c similar to those in FIG. 3, and also includes a housing receiving portion 104b. The housing receiving portion 104b is formed in a cylindrical shape so as to extend from the opening 104c away from the light-transmitting plate section Est. The housing 105 is housed in the housing receiving portion 104b. The housing receiving portion 104b may define a notch through which a connector 107a passes when the housing 105 is housed in the housing receiving portion 104b. The hood 105b has an upper hood and a lower food that have an approximately symmetrical shape with each other. The taper angle of the upper hood is approximately equal to the taper angle of the lower hood. The hood 105b defines a sound guiding hole 105c that fluidly connects the MEMS microphone 103a of the acoustic sensor 103 mounted on the circuit board 106 and the light-shielding space Sp1, as in the example shown in FIG. 3.

Next, the installation process of the on-vehicle device 101 onto the vehicle Ve shown in FIG. 4 will be described with reference to FIGS. 5 to 8. The installation process represents a part of the manufacturing method of the on-vehicle device 101 or the vehicle Ve. In the first step shown in FIG. 5, adhesive 9a is applied to the mounting portion 104a of the bracket 104, and the bracket is pressed against the light-transmitting plate portion Est of the B-pillar Ps4. When the adhesive 9a dries, the bracket 104 is fixed to the light-transmitting plate portion Est.

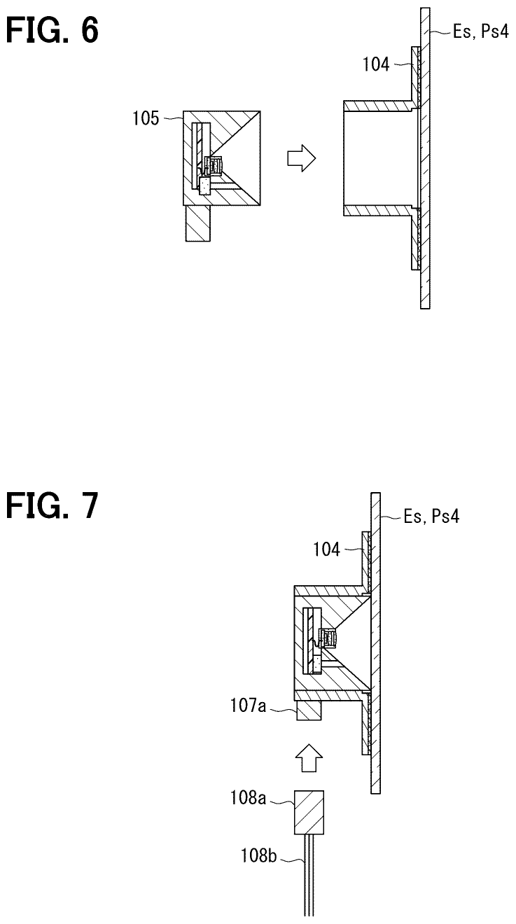

In the second step shown in FIG. 6, the housing 105, in which the camera 102a and the acoustic sensor 103 are assembled, is inserted into the housing receiving portion 104b of the bracket 104. As a result, the camera 102a and the acoustic sensor 103 are fixed to the light-transmitting plate portion Est and the bracket 104. In the third step shown in FIG. 7, a connector 108a of a harness 108b is connected to a connector 107a of the housing 105. As a result, both control circuits 102b and 103b are electrically connected to the vehicle ECU (electronic control unit) 0 in a state where the camera 102a and the acoustic sensor 103 share the harness 108b. With the above steps, the installation of the on-vehicle device 101 onto the vehicle Ve is completed.

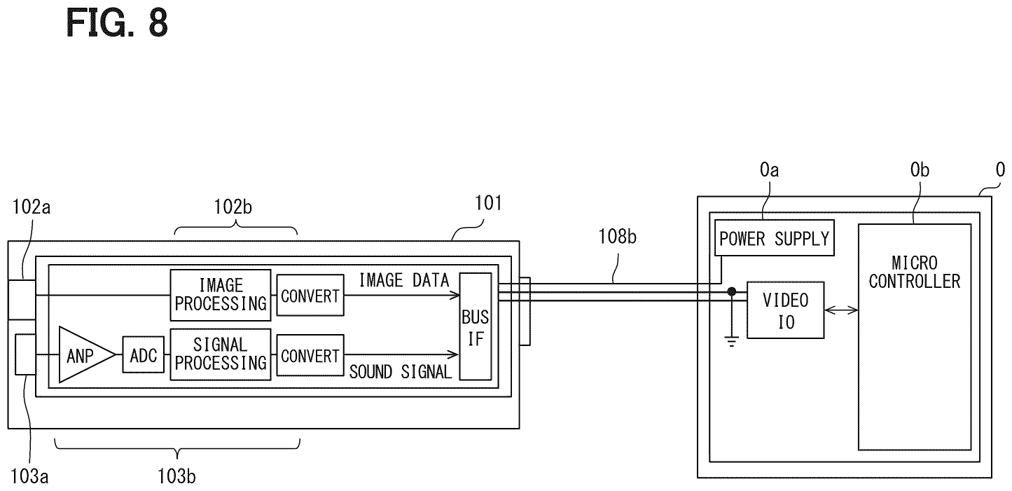

Here, communication between the on-vehicle device 101 and the ECU 0 will be explained with reference to FIG. 8. In the on-vehicle device 101, the control circuit 102b of the camera performs image processing and data format conversion of the detection signal obtained by the image sensor of the camera 102a, thereby generating image data. The analog electrical signal obtained by the microphone 103a of the acoustic sensor 103 is amplified by an amplifier in the control circuit 103b, and then converted into a digital signal by an A/D conversion circuit in the control circuit 103b. The digital signal further undergoes signal processing and data format conversion, thereby generating a sound signal.

The image data and sound signal are transmitted to the ECU 0 via the shared harness 108b from the same bus interface (bus IF). Here, the harness 108b includes three types of lines: a power supply line, a GND line, and a communication line. The wiring shared by the image data and sound signal may be at least one of these three types of wiring, and it is more preferable that all three types of wiring are shared.

Communication between the on-vehicle device 101 and the ECU 0 may be high-speed serial communication such as LVDS (Low Voltage Differential Signaling) or A2B (Automotive Audio Bus; A2B is a registered trademark). With such communication, the digitized sound signal is transferred to the ECU 0.

The ECU 0 is a processing device that executes necessary processing in the vehicle Ve. The ECU 0 includes a power supply 0a, video input/output terminals, and a microcontroller 0b. The power supply 0a supplies power to the camera 102a and the acoustic sensor 103 of the on-vehicle device 101 via the power line of the harness 108b. The microcontroller 0b acquires image data and sound signals transmitted from the on-vehicle device 101 via the video input/output terminals. The microcontroller 0b may use the image data and sound signals for the same purpose or may use each for a different purpose.

According to the first embodiment described above, in the on-vehicle devices 1 and 101, the electromagnetic element 2, 102 and the acoustic sensor 3, 103 are integrated with each other. Thus, securing installation space for the acoustic sensor 3, 103 in the vehicle Ve becomes easier, and it is also possible to suppress an increase in the person-hours required for mounting the acoustic sensor 3, 103 onto the vehicle Ve. Accordingly, it is possible to provide the on-vehicle device 1, 101 that is suitable for installation in the vehicle Ve.

Further, according to the first embodiment, the on-vehicle device 1, 101 includes the housing 5, 105 that accommodates the electromagnetic element 2, 102. The acoustic sensor 3, 103 is housed in the same housing 5, 105, and includes microphone 3a, 103a that detects air vibrations as acoustics. Since the microphone 3a, 103a utilizes the air present in the internal space of the housing 5, 105 that accommodates the electromagnetic element 2, 102, it is possible to detect acoustics while saving a space.

Further, according to the first embodiment, the electromagnetic element 2, 102 is the camera 2a, 102a that captures images of the outside of the device. The housing 5, 105 includes the hood 5b, 105b that blocks diffusely reflected light entering from outside the device. The hood 5b, 105b has a shape corresponding to the angle of view of the camera 2a, 102a, in which the width of the internal space increases gradually as the distance between the hood 5b, 105b and the camera 2a, 102a increases. The housing 5, 105 further includes the board housing portion 5a, 105a that houses the circuit board 6, 106. The circuit board 6, 106 is shared between the camera 2a, 102a and the acoustic sensor 3, 103, and mounts the microphone 3a, 103a. The hood 5b, 105b defines the sound guiding holes 5c, 105c that fluidly connects the microphone 3a, 103a and the internal space. The hood, whose structure is similar to a horn structure for the camera 2a, 102a, increases the sound pressure. As a result, sound can be detected with the greater sound pressure, thereby improving the sound detection performance.

Further, according to the first embodiment, the harness that electrically connects the electromagnetic element 102 to the ECU 0, which is a separate device in the vehicle Ve, is shared with the harness that electrically connects the acoustic sensor 103 to the ECU 0. By using the harness 108b between the electromagnetic element 102 and the acoustic sensor 103, it is possible to further suppress an increase in person-hours required for the installation.

Further, according to the first embodiment, the acoustic sensor 103 generates a sound signal by converting the detected analog electrical signal into a digital signal. Then, the acoustic sensor uses the communication line through which the electromagnetic element 102 communicates with the ECU 0, which is a separate device in the vehicle Ve, by transmitting digital signals as a communication line through which the acoustic sensor 103 communicates with another device by transmitting digital signals. Using the digitized sound signal makes the transmission of detection results from the electromagnetic element 102 and the acoustic sensor 103 more efficient.

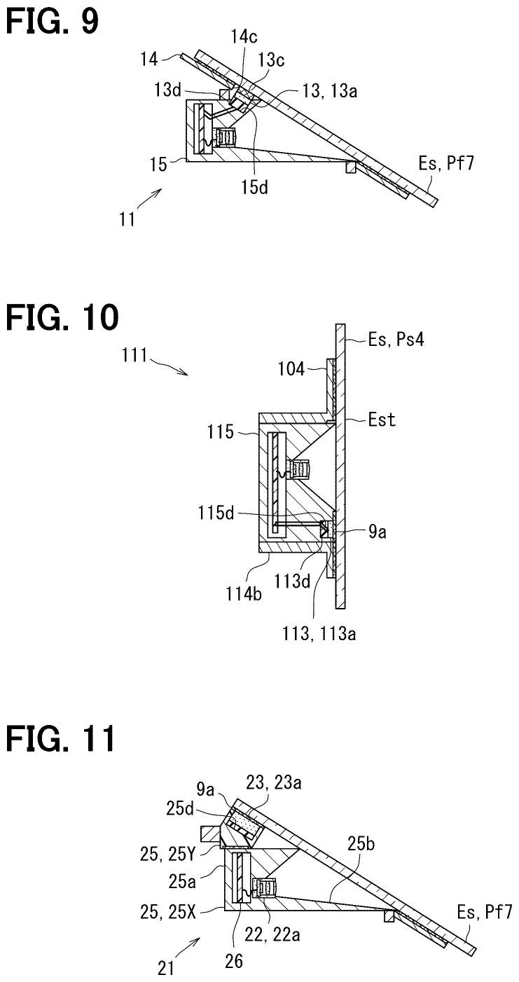

(Second Embodiment) As shown in FIGS. 9 and 10, the second embodiment is a modification of the first embodiment. The second embodiment will be described mainly with respect to points that differ from the first embodiment.

In the example of FIG. 9, as in the example of FIG. 3, an on-vehicle device 11 is attached to the windshield Pf7, which serves as the external structure Es. The example of FIG. 9 will be described mainly with respect to points that differ from the example of FIG. 3. In this example, the microphone of the acoustic sensor 13 is a piezo microphone 13a. The piezo microphone 13a includes a piezoelectric element and a metal plate. The piezoelectric element is formed in a thin plate shape. The piezoelectric element has a positive electrode on its front surface, and a negative electrode on its back surface. The piezoelectric element generates a voltage between the electrodes in accordance with the applied stress. The metal plate is formed in a thin plate shape with a larger surface area than the piezoelectric element. The metal plate vibrates integrally with the piezoelectric element in response to vibrations transmitted to the piezo microphone 13a. The piezo microphone 13a may include a thick piezoelectric element instead of a combination of a piezoelectric element and a metal plate.

Accordingly, the piezo microphone 13a is disposed at a position where the vibrations of the windshield Pf7 are directly transmitted. The opening 14c of the bracket 14 has a space for positioning the piezo microphone 13a to face the windshield Pf7. The housing 15 has a recess 15d in the outer wall at a position facing the windshield Pf7 above the hood, for accommodating the piezo microphone 13a. Approximately half of the volume of the piezo microphone 13a is embedded in the recess 15d (e.g., a cylindrical recess) with the front and back surfaces of the piezo microphone 13a sandwiched between elastic members 13c and 13d.

Here, it is preferable that the elastic member 13c on the front surface of the piezo microphone 13a is a viscoelastic material having both viscosity and elasticity. The viscoelastic material is a double-sided tape or adhesive that functions as an acoustic matching material. The piezo microphone 13a is disposed to be pressed against the windshield Pf7 via the viscoelastic material. The elastic member 13d on the back surface of the piezo microphone 13a may be a resin spring, a metal spring, or rubber. As a result, it is possible to efficiently transmit vibrations of the windshield Pf7 to the piezo microphone 13a while absorbing differences in the shape of the windshield Pf7 depending on the vehicle model and installation position errors.

In the example of FIG. 10, as in the example of FIG. 4, an on-vehicle device 111 is attached to the light-transmitting plate portion Est of the B-pillar Ps4, which serves as the external structure Es. The microphone of the acoustic sensor 113 is a piezo microphone 113a. The housing 115, which is accommodated in the housing receiving portion 114b of the bracket 114, has a recess 115d for embedding the entire piezo microphone 113a at a position adjacent to the hood and facing the light-transmitting plate portion Est.

An elastic member 113d is provided on the back surface of the piezo microphone 113a, as in the example of FIG. 9. On the other hand, an adhesive 9a for attaching the bracket 114 is disposed between the front surface of the piezo microphone 113a and the light-transmitting plate portion Est. As a result, the adhesive 9a functions in the same way as the viscoelastic body in the example of FIG. 9.

According to the second embodiment described above, the on-vehicle device 11, 101 is fixed to the external structure Es of the vehicle Ve, and includes the housing 15, 115 that accommodates the electromagnetic element 12, 112. The acoustic sensor 13, 113 is held on the outer wall of the housing 15, 115 so as to share the housing 5, 115 with the electromagnetic element 12, 112. The acoustic sensor 13, 113 includes the microphone 13a, 113a that detects vibrations of the external structure Es, and is disposed at a position where vibrations of the external structure Es are transmitted. By holding the acoustic sensor 13, 113 on the outer wall, it is possible to both suppress an increase in person-hours required for installing the on-vehicle device 11, 101 on the vehicle and achieve high acoustic detection performance.

In addition, according to the second embodiment, the microphone 13a, 113a is in close contact with the external structure Es with elastic members 13c and 113c, serving as viscoelastic bodies, interposed between the microphone 13a, 113a and the external structure Es. With this configuration, it is possible to easily enhance the vibration transmissibility between the microphone 13a, 113a and the external structure Es, while suppressing an increase in person-hours required for the installation.

In addition, according to the second embodiment, the microphone 13a, 113a is in close contact with the external structure Es with the elastic member 13d, 113d interposed between the microphone 13a, 113a and the housing 15, 115. Since the elastic member 13d, 113d absorbs dimensional errors during installation, mounting can be facilitated.

(Third Embodiment) As shown in FIGS. 11 to 15, the third embodiment is a modification of the first embodiment. The third embodiment will be described mainly focusing on the points that differ from the first embodiment.

In the example shown in FIG. 11, as in the example of FIG. 3, an on-vehicle device 21 is mounted on the windshield Pf7, which serves as the external structure Es. The example shown in FIG. 11 will be described mainly focusing on the points that differ from the example in FIG. 3. In this example, a housing 25 includes a first housing component 25X and a second housing component 25Y that are integrally formed with each other. The first housing component 25X accommodates a camera 22a, which serves as an electromagnetic element 22. The first housing component 25X includes a board housing portion 25a and a hood 25b. The board housing portion 25a houses a circuit board 26 exclusively for mounting the control circuit of the camera 22a.

The second housing component 25Y accommodates an acoustic sensor 23. The second housing component 25Y is fixed to the first housing component 25X by adhesion with adhesive, engagement, or fastening. The second housing component 25Y has a recess 25d at a position facing the windshield Pf7. The recess 25d accommodates a microphone 23a of the acoustic sensor 23. The microphone may be a condenser microphone or a piezo microphone, but since it is difficult to provide a space in the recess 25d for generating air vibrations detected by a condenser microphone, it is more suitable that the microphone is a piezo microphone.

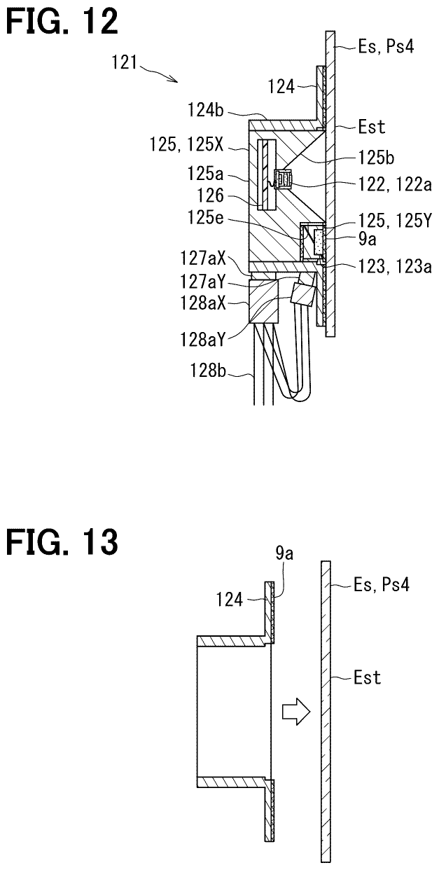

In the example of FIG. 12, as in the example of FIG. 4, an on-vehicle device 121 is attached to the light-transmitting plate portion Est of the B-pillar Ps4, which serves as the external structure Es. A housing 125 accommodated in the housing receiving portion 124b of the bracket 124 includes a first housing component 125X and a second housing component 125Y. The first housing component 125X accommodates a camera 122a, which serves as an electromagnetic element 122. The first housing component 125X includes a board housing portion 125a and a hood 125b. The board housing portion 125a accommodates a circuit board 126 exclusively for mounting the control circuit of the camera 122a. The first housing component 125X defines a space at a corner portion 125e, which is adjacent to the hood 125b and faces the light-transmitting plate portion Est, for arranging the second housing component 125Y.

The second housing component 125Y accommodates the acoustic sensor 123. The second housing component 125Y is fixed to the first housing component 125X by adhesion with an adhesive, engagement, or fastening. The integrated first housing component 125X and second housing component 125Y form the tubular housing 125 with substantially no gap relative to the housing receiving portion 124b.

A connector 127a of the first housing component 125X and a connector 127a of the second housing component 125Ys are separate members from each other as connectors of the housing 125. On the other hand, the connector of the harness 128b is configured such that wiring is branched from a connector 128aX for the first housing component 125X to a connector 128aY for the second housing component 125Y, thereby allowing a part of the harness 128b to be shared between the camera 122a and the acoustic sensor 123, and the control circuits of the camera 122a and the acoustic sensor 123 are electrically connected to the ECU 0.

Next, the process of installing the on-vehicle device 121 of FIG. 12 onto the vehicle Ve will be explained with reference to FIGS. 13 to 15. In the first step shown in FIG. 13, adhesive 9a is applied to the mounting portion of bracket 124, and the bracket is pressed against the light-transmitting plate portion Est of the B-pillar Ps4. When the adhesive 9a dries, the bracket 124 is fixed to the light-transmitting plate portion Est.

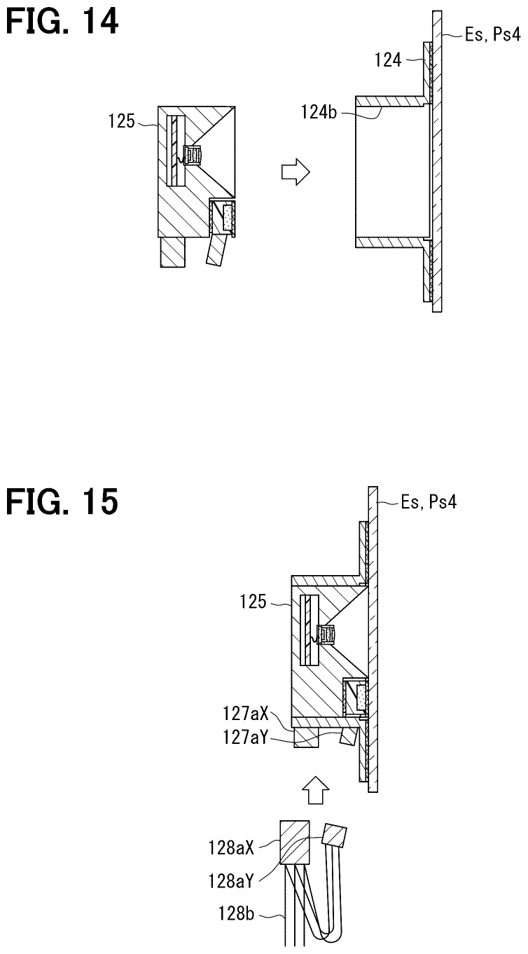

In the second step shown in FIG. 14, the housing 125, which is formed of the first housing component 125X and the second housing component 125Y that have been integrated in advance, and in which the camera 122a and the acoustic sensor 123 are assembled, is inserted into the housing receiving portion 124b of the bracket 124. As a result, the camera 122a and the acoustic sensor 123 are fixed to the light-transmitting plate portion Est and the bracket 124. In the third step shown in FIG. 15, the two connectors 128aX and 128aY of the harness 128b are respectively connected to the two connectors 127aX and 127aY of the housing 125. With the above steps, the installation of the on-vehicle device 121 onto the vehicle Ve is completed.

According to the third embodiment described above, the on-vehicle device 21, 121 includes the first housing component 25X, 125X that accommodates the electromagnetic element 22, 122, and the second housing component 25Y, 125Y that accommodates the acoustic sensor 23, 123. The acoustic sensor 23, 123 is integrated with the electromagnetic element 22, 122 by fixing the second housing component 25Y, 125Y to the first housing component 25X, 125X. Such integration makes it possible to suppress an increase in the number of installation steps required to mount the on-vehicle device 21, 121 onto the vehicle Ve.

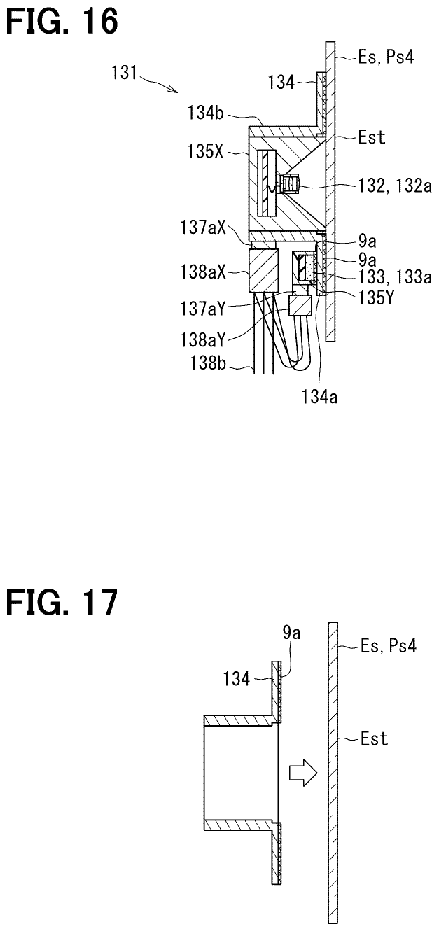

(Fourth Embodiment) As shown in FIGS. 16 to 19, the fourth embodiment is a modification of the first embodiment. The fourth embodiment will be described, focusing on the points that differ from the first embodiment.

In the example of FIG. 16, as in the example of FIG. 4, an on-vehicle device 131 is mounted on the light-transmitting plate portion Est of the B-pillar Ps4, which serves as the external structure Es. The example of FIG. 16 will be explained with a focus on the differences from the example of FIG. 4. In this example, a first housing component 135X and a second housing component 135b are provided separately. The first housing component 135X is accommodated in a housing receiving portion 134b of the bracket 134, and accommodates a camera 132a, which serves as an electromagnetic element 132.

The second housing component 135Y accommodates an acoustic sensor 133. The second housing component 135Y is fixed to the plate-shaped mounting portion 124a of the bracket 124. Specifically, the second housing component 135Y is attached to the back surface of the mounting portion 134a, which is a surface of the mounting portion 134a opposite to the light-transmitting plate portion Est, with an adhesive 9a.

The second housing component 135Y has a recess at a position facing the light-transmitting plate portion Est through the mounting portion 124a. The recess accommodates a microphone 133a of the acoustic sensor 133. The microphone 133a may be a condenser microphone or a piezo microphone. However, a piezo microphone that directly detects the vibrations of the B-pillar Ps4 and the mounting portion 134a is more suitable since it is difficult to provide a space in the recess for generating air vibrations to be detected by a condenser microphone.

A connector 137a of the first housing component 135X and a connector 137a of the second housing component 135Y are separately provided as connectors of the on-vehicle device 131. The connectors 138aX and 138Y of the harness 138b are the same as those in the example shown in FIG. 12.

Next, the installation process of the on-vehicle device 131 onto the vehicle Ve shown in FIG. 16 will be described with reference to FIGS. 17 to 19. In the first step shown in FIG. 17, adhesive 9a is applied to the mounting portion 134a of the bracket 134 and pressed against the light-transmitting plate portion Est of the B-pillar Ps4. When the adhesive 9a dries, the bracket 134 is fixed to the light-transmitting plate portion Est.

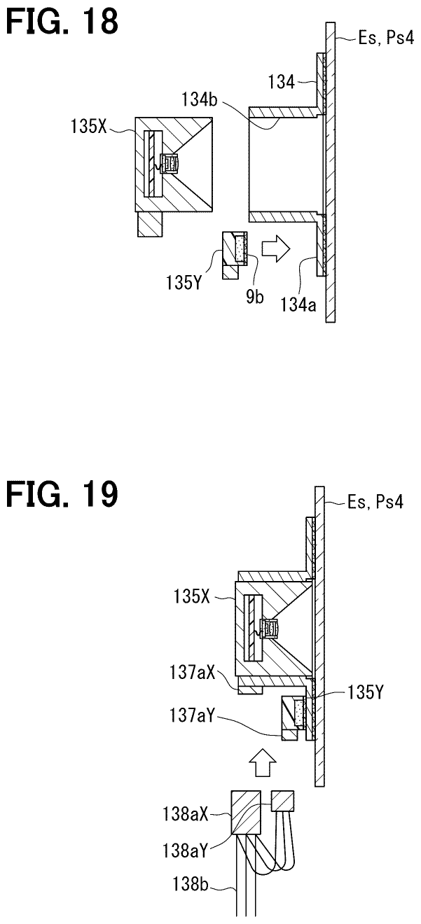

In the second step shown in FIG. 18, the first housing component 135X into which the camera 132a is assembled is inserted into the housing receiving portion 134b of the bracket 134. As a result, the camera 132a is fixed to the light-transmitting plate portion Est and the bracket 134. In addition, adhesive 9b is applied to the second housing component 135Y into which the acoustic sensor 133 is assembled, specifically a surface of the piezo microphone 133a to be in contact with the back surface of the mounting portion 134a of the bracket 134. Then, the second housing component 135Y is pressed against the back surface. When the adhesive 9b dries, the acoustic sensor 133 is fixed to the light-transmitting plate portion Est and the bracket 134. In the third step shown in FIG. 19, the two connectors 138aX and 138aY of the harness 138b are respectively connected to the two connectors 137aX and 137aY of the on-vehicle device 131. With the above steps, the installation of the on-vehicle device 131 onto the vehicle Ve is completed.

According to the fourth embodiment described above, the on-vehicle device 131 includes the bracket 134 that is attached to the external structure Es of the vehicle Ve. In addition, the on-vehicle device 131 includes the first housing component 135X that accommodates the electromagnetic element 132, and the second housing component 135Y that accommodates the acoustic sensor 133. Then, the acoustic sensor 133 is integrally formed with the electromagnetic element 132 by fixing the first housing component 135X and the second housing component 135Y to the bracket 134. Such integration makes it possible to suppress an increase in the number of installation steps required to mount the on-vehicle device 21, 121 onto the vehicle Ve.

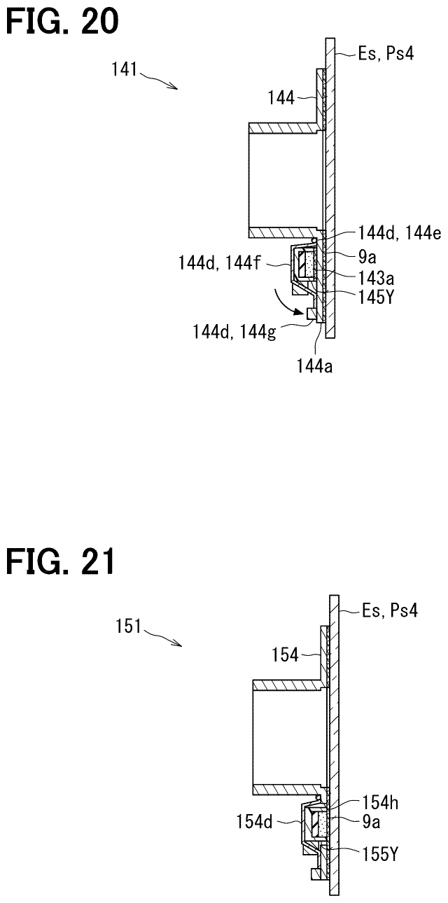

(Fifth Embodiment) As shown in FIGS. 20 and 21, the fifth embodiment is a modification of the fourth embodiment. The fifth embodiment will be described mainly with respect to points that differ from the fourth embodiment.

In on-vehicle devices 141 and 151 of the fifth embodiment, a second housing component 145Y, 155Y is attached to the back surface of the mounting portion 144a of the bracket 144, 154 with a retainer spring 144d, 154d instead of adhesive. It should be noted that in FIGS. 20 and 21, the illustrations of the first housing component and the camera are omitted.

In the example of FIG. 20, the retainer spring 144d is disposed on the back surface of the mounting portion 144a. The retainer spring 144d may be formed of metal, and includes a rotational shaft 144e, an engaging portion 144g, and a pressing portion 144f. The rotational shaft 144e is fixed to a position of the mounting portion 144a that is offset from the position facing the second housing component 125Y. The rotational shaft 144e is connected to the pressing portion 144f such that the pressing portion 144f can rotate about the rotational shaft 144e, within the space above the back surface of the mounting portion 144a. The rotational shaft 144e exerts an elastic reaction force that urges the pressing portion 144f toward the mounting portion 144a, using a coil spring, for example.

The engaging portion 144g is fixed to the mounting portion 144a on the side of the second housing component 145Y opposite to the rotational shaft 144e. The engaging portion 144g is engageable with the tip end of the pressing portion 144f. The pressing portion 144f is formed in a plate-like or rod-like shape extending to a length sufficient to reach the engaging portion 144g. The pressing portion 144f is configured to move, with the above-described rotation, from a separated state where the pressing portion 144f is separated from the engaging portion 144g before the second housing component 145Y is attached to the mounting portion 144a to a state in which the pressing portion 144f can engage with the engaging portion 144g during the assembly of the second housing component 145Y.

The pressing portion 144f presses the second housing component 145Y toward the light-transmitting plate portion Est or the mounting portion 144a with the tip end of the pressing portion 144f is engaged with the engaging portion 144g. As a result, the piezo microphone 143a can be brought into close contact with the light-transmitting plate portion Est and the mounting portion 144a without using an adhesive 9a, allowing the piezo microphone 143a to directly detect vibrations from these components. On the other hand, as shown in FIG. 20, applying adhesive 9a to the surface of the piezo microphone 143a to be in contact with the rear surface of the mounting portion 144a among the second housing components 145Y increases the degree of adhesion.

The pressing portion 144f may directly press the main body portion of the second housing component 145Y into which the microphone 143a is housed. On the other hand, the second housing component 145Y may have a flange protruding from the main body in a direction substantially parallel to the extending direction of the mounting portion, and the pressing portion 144f may press the flange.

In the example shown in FIG. 21, the bracket 154 of the on-vehicle device 151 has an opening 154h formed at a position facing the second housing component 155Y. As with the retainer spring 154d in FIG. 20, the second housing component 155Y is pressed directly against the light-transmitting plate portion Est through the opening 154h.

According to the fifth embodiment described above, the on-vehicle device 141, 151 includes the retainer spring 144d, 154d, which press the second housing component 145Y, 155Y toward the external structure Es by elasticity. This structure allows vibrations of the external structure Es to transmit more easily to the second housing component 145Y, 155Y, thereby improving the performance of acoustic detection.

In addition, the bracket 154 has the opening 154h at a position facing the external structure Es. The on-vehicle device 151 further includes the retainer spring 154d that presses the second housing component 155Y directly against the external structure Es through the opening 154h by elasticity. This structure allows vibrations of the external structure Es to transmit more easily to the second housing component 155Y, thereby improving the performance of acoustic detection.

(Sixth Embodiment) As shown in FIGS. 22 to 24, the sixth embodiment is a modification of the first embodiment. The sixth embodiment will be described mainly with a focus on the points that differ from the first embodiment.

In the sixth embodiment, an on-vehicle device 201 is mounted on an external structure Es such as a body, bumper, or grille. The external structure Es defines an opening Eso through which the on-vehicle device 201 is exposed to the outside.

In the example of FIG. 22, the housing 205 accommodated in the housing receiving portion 204b of the bracket 204 includes a barrel portion 205f and a board holding portion 205g. The barrel portion 205f is formed in a cylindrical shape to accommodate a lens system 202c of the camera 202a, which serves as an electromagnetic element 202. The lens system 202c includes multiple lenses 202d, 202e, and 202f. The frontmost exposed lens 202d is disposed in the opening Eso and is exposed to the external environment of the vehicle Ve.

The board holding portion 205g is disposed on the back side of the barrel portion 205f. That is, the other lenses are disposed between the board holding portion 205g and the exposed lens 202d. The board holding portion 205g closes off the housing 205 from the rear back and defines therein a holding space for retaining the circuit board 206. The board holding portion 205g holds the circuit board 206 by sandwiching the circuit board 206 between the board holding portion 205g and the barrel portion 205f, thereby positioning the circuit board 206 to face the lens system 202c along the optical axis Ao of the lens system 202c. An imaging element 202g is mounted on the circuit board 206 on the optical axis Ao of the lens system 202c.

The microphone of the acoustic sensor 203 is a condenser microphone, specifically a MEMS microphone 203a. The MEMS microphone 203a shares the circuit board 206 with the imaging element 202g. The MEMS microphone 203a is disposed on the circuit board 206, offset from the imaging element 202g and outside the optical axis Ao, and oriented toward the lens system 202c. The MEMS microphone 203a detects air vibrations within the space formed for accommodating the lens system 202c. That is, the MEMS microphone 203c measures sounds that are re-radiated by vibrations of the lenses 202d, 202e, and 202f of the lens system 202c, which are caused by sounds generated in the external environment.

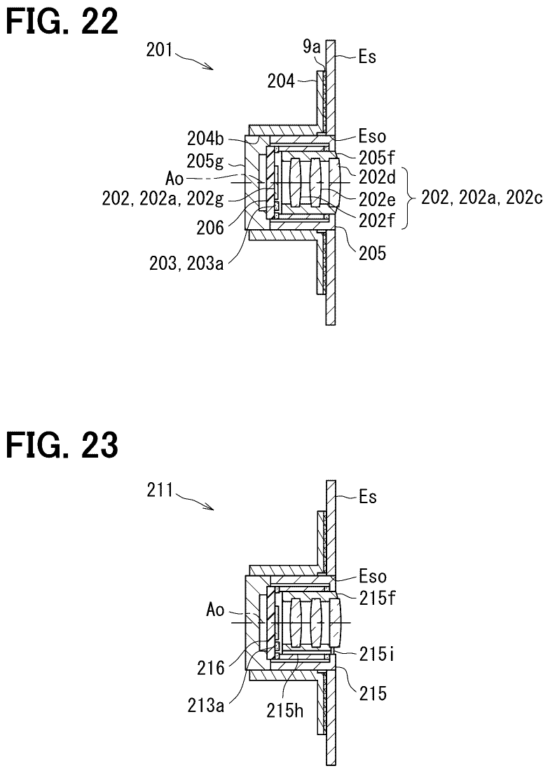

In the on-vehicle device 211 of the example shown in FIG. 23, the lens barrel portion 215f defines a sound guiding hole 215h that fluidly connects the front end and the back end of the lens barrel portion 215f along the direction of the optical axis Ao. The sound guiding hole 215h, similar to the example in FIG. 3, is an elongated tubular hole with a circular cross-section that extends linearly. The front end of the sound guiding hole 215h that is exposed to the external environment is sealed with a sound-permeable filter 215i that provides both sound permeability and waterproof properties. The sound-permeable filter 215i may be formed in a membrane or thin plate shape. The back end of the sound guiding hole 215h faces the MEMS microphone 213a mounted on the circuit board 216.

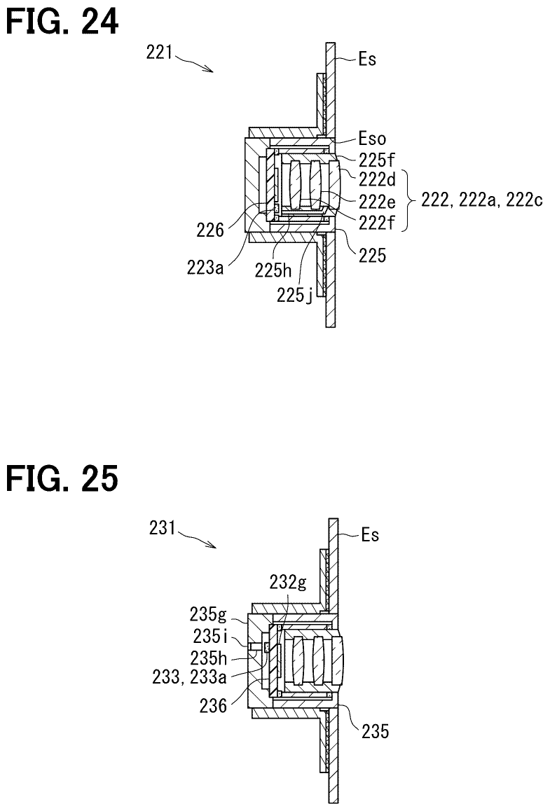

In the example of the on-vehicle device 221 shown in FIG. 24 as well, the lens barrel portion 225f defines a sound guiding hole 225h. In the example shown in FIG. 24, the sound guiding hole 225h fluidly connects the back end of the lens barrel portion 225f and the space formed between the multiple lenses 222d, 222e, and 222f in the lens system 222c. For example, the sound guiding hole 225h includes a bent portion 225j. The sound guiding hole 225h extends from the back end of the lens barrel portion 225f, and is bent at the bent portion 225j to a position of the inner wall of the lens barrel portion 225f between the exposed lens 222d and the second lens 222e that faces the exposed lens 222d. In this case, the sound guiding hole 225h is not directly exposed to the external environment, thereby eliminating a sound-permeable filter.

According to the sixth embodiment described above, the on-vehicle device 211, 221 includes the housing 215, 235 that accommodates the electromagnetic element 202. The acoustic sensor 203 is housed in the housing 215 and includes the microphone 213a that detects air vibrations as acoustics. The housing 215 defines the sound guiding hole 215h that fluidly connects the microphone 213a and the outside of the device. The sound guiding hole 215h directly guides external sounds to the microphone 213a, thereby improving detection performance.

The sound guiding hole 215h provides fluid communication between the microphone 213a and the surrounding environment external to the device, namely the periphery of the vehicle Ve. The housing 215 further includes the sound-permeable filter 215i, which is disposed to cover the sound guiding hole 215h and has both sound permeability and waterproof properties. Thus, it is possible to prevent foreign matter from entering the interior of the housing 215 from the external environment through the sound guiding hole 215h. Accordingly, it is possible to provide the on-vehicle device 211 capable of maintaining its detection performance over an extended period.

In addition, according to the sixth embodiment, the on-vehicle device 221 includes the housing 225 that accommodates the electromagnetic element 202 and the acoustic sensor 223. The acoustic sensor 223 includes the microphone 223a that detects air vibrations as acoustics. The electromagnetic element 202 has the lens system 222c that includes multiple lenses, including the exposed lens 222d that is exposed to the surrounding environment of the vehicle Ve, and other lenses 222e and 222f. The housing 225 defines the sound guiding hole 225h that fluidly connects the microphone 223a and the space formed between the exposed lens 222d and the other lenses 222e and 222f within the lens system 222c. In this configuration, the exposed lens 222d serves both as a functional component for the electromagnetic element 202 and as a sound permeable filter for the sound guiding hole 225h. Accordingly, it is possible to suppress the entry of foreign matter into the housing 225 through the sound guiding hole 225h from the external environment, thereby allowing the detection performance to be maintained over an extended period.

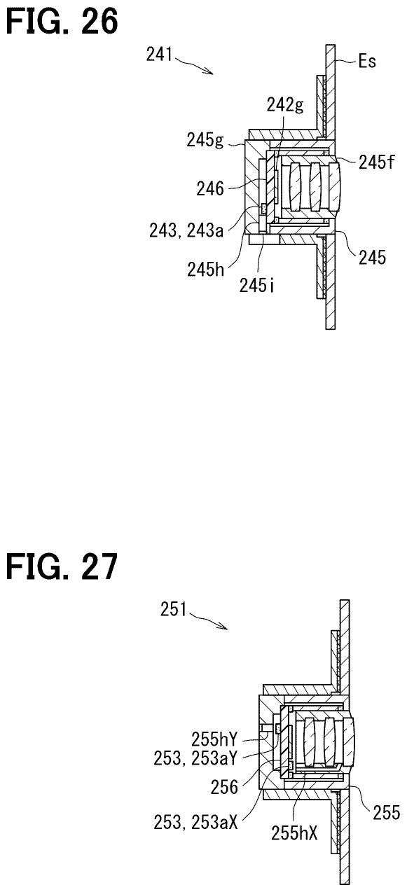

(Seventh Embodiment) As shown in FIGS. 25 and 26, the seventh embodiment is a modification of the sixth embodiment. The seventh embodiment will be described mainly focusing on the points that differ from the sixth embodiment. In the seventh embodiment, the sound-collecting performance is enhanced not only outside the vehicle Ve but also within the interior space of the vehicle Ve.

In the on-vehicle device 231 shown in the example of FIG. 25, a MEMS microphone 233a is mounted on the back surface of the circuit board 236, which is the surface opposite to the front surface where the image sensor 232g is mounted. The bottom surface of the board holding portion 235g that covers the back side of the housing 235 defines a sound guiding hole 235h. The sound guiding hole 235h fluidly connects a position inside the housing 235 that faces the MEMS microphone 233a and the outside of the device. In this example, the acoustic sensor 233 can easily detect sounds in the interior space of the vehicle Ve, which is a space on the side opposite to the external structure Es. A sound-permeable filter 235i may be provided at the end of the sound guiding hole 235h that is exposed to the interior space of the vehicle Ve.

In the on-vehicle device 241 of the example shown in FIG. 26, the wall portion of the board holding portion 245g that protrudes in a tubular shape from the bottom surface toward the lens barrel portion 245f defines a sound guiding hole 245h. The MEMS microphone 243a is mounted on the back surface of the circuit board 246 that is opposite to the front surface on which the image sensor 242a is mounted. The MEMS microphone 243a is mounted at a position offset from the center of the circuit board 246 (on the optical axis) toward the wall portion. The sound guiding hole 245h fluidly connects the vicinity of the MEMS microphone 243a that is in the housing and the outside of the housing. In this example as well, the acoustic sensor 243 can easily detect the acoustics within the interior space of the vehicle Ve. A sound-permeable filter 245i may be provided at the end of the sound guiding hole 245h that is exposed to the interior space of the vehicle Ve.

(Eighth Embodiment) As shown in FIG. 27, the eighth embodiment is a modification of the sixth and seventh embodiments. The eighth embodiment will be described mainly with respect to points that differ from the sixth and seventh embodiments.

In the example shown in FIG. 27, a MEMS microphone 253aX and a sound guiding hole 255hX corresponding to the example of FIG. 24, and a MEMS microphone 253aY and a sound guiding hole 255hY corresponding the example of FIG. 25 are provided. That is, it is possible to detect sound having directivity toward the external environment of the vehicle Ve, as well as to detect sound having directivity within the internal space of the vehicle Ve.

Then, the acoustic sensor 253 synthesizes sound signals of analog electrical signals detected by the two MEMS microphones 253aX and 253aY or sound signals of digital signals that are converted from the detected analog electrical signals with the control circuit mounted on the circuit board 256. Through the synthesis processing here, processing to enhance detection performance by active noise canceling may be performed.

According to the eighth embodiment described above, the on-vehicle device 251 includes the housing 255 that accommodates the electromagnetic element and the acoustic sensor 253. The acoustic sensor 253 includes a first microphone 253aX that is housed in the housing 255 and detects air vibrations as acoustics, and a second microphone 253aY that is a separate member from the first microphone 253aX, housed in the housing 255, and detects air vibrations as acoustics. The housing 255 defines the first sound guiding hole 255hX that guides sounds from the external environment of the vehicle Ve to the first microphone 253aX, and the second sound guiding hole 255hY that guides sounds from the interior space of the vehicle Ve to the second microphone 253aY. Thus, it is possible to detect both sounds from the external environment and sounds from the interior space of the vehicle Ve, making it possible to use the sounds for performance improvements such as noise canceling.

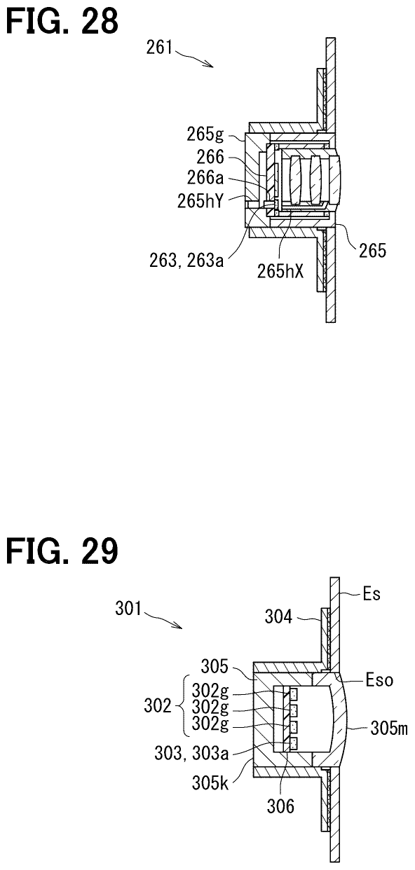

(Ninth Embodiment) As shown in FIG. 28, the ninth embodiment is a modification of the sixth embodiment. The ninth embodiment will be described mainly with respect to the points that differ from the sixth embodiment.

The example of FIG. 28 improves the sound collection performance toward the interior of the vehicle Ve for the MEMS microphone 263a that corresponds to the example of FIG. 24. Specifically, the circuit board 266 defines a sound guiding hole 266a directly beneath the mounting position of the MEMS microphone 263a. Furthermore, the bottom of the board holding portion 265g defines a sound guiding hole 265hY at a position linearly extended from the sound guiding hole 266a.

As a result, the single MEMS microphone 263a can perform both detection of sound with directivity toward the external environment of the vehicle Ve and detection of sound with directivity toward the interior. The acoustic sensor 263 can execute processing to enhance detection performance through passive noise canceling, by a control circuit mounted on the circuit board 266.

According to the ninth embodiment described above, the on-vehicle device 261 includes the housing 265 that accommodates the electromagnetic element and the acoustic sensor 263. The acoustic sensor 263 includes the microphone 263a that detects air vibrations as acoustics. The housing 265 defines the first sound guiding hole 265hX that guides sound from the external environment of the vehicle Ve to the microphone 263a, and the second sound guiding hole 265hY that guides sound from the interior space of the vehicle Ve to the microphone 263a. Thus, it is possible to detect both sounds from the external environment and sounds from the interior space of the vehicle Ve, making it possible to use the sounds for performance improvements such as noise canceling.

(Other Embodiments) As described above, although multiple embodiments have been explained, the present disclosure is not to be construed as limited to these embodiments, and can be applied to various embodiments and combinations thereof without departing from the gist of the present disclosure.

As another embodiment, in the example of the on-vehicle device 301 shown in FIG. 29, a LiDAR or a lighting device as an electromagnetic element 302 and an acoustic sensor 303 are integrated with each other. This on-vehicle device 301 is mounted on an external structure Es such as the body, bumper, or grille. The external structure Es defines an opening Eso through which the on-vehicle device 301 is exposed to the outside.

The bracket 304 is the same as in the example of FIG. 22. The housing 305 is accommodated in the cylindrical portion of the bracket 304. The housing 305 includes a bottomed, cup-shaped board holding portion 305k, and a light-transmitting cover 305m, which may be formed of glass or acrylic resin and closes the board holding portion 305k from the front side of the board holding portion 305k.

The circuit board 306 is held by the board holding portion 305k in the internal space of the housing 305, which is defined by the board holding portion 305k and the light-transmitting cover 305m. The circuit board 306 mounts the electromagnetic device 302g and the MEMS microphone of the acoustic sensor 303 on the front surface that facing the light-transmitting cover 305m.

When the electromagnetic element 302 is a LiDAR, the electromagnetic device 302g serves as a light-emitting element that emits laser light and a light-receiving element that receives laser light. When the electromagnetic element 302 is a lighting device, the electromagnetic device 302g serves as a light-emitting element such as an LED.

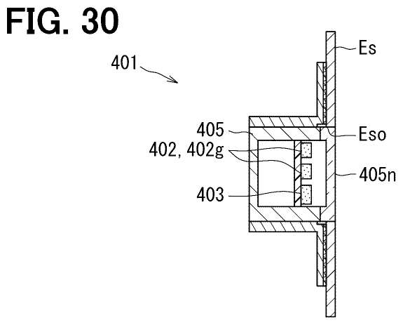

As another embodiment, in the example of the on-vehicle device 401 shown in FIG. 30, a millimeter-wave radar as the electromagnetic element 402 and an acoustic sensor 403 are integrated with each other. The on-vehicle device 401 is attached to the external structure Es, such as the body, bumper, or grille. As a difference from FIG. 29, since the millimeter-wave radar handles millimeter waves, not visible lights. Thus, the light-transmitting cover of the housing 405 may be replaced by a cover portion 405n formed of colored synthetic resin. The electromagnetic wave device 402g may be an antenna array that transmits and receives millimeter waves.

The control unit and its method described in the present disclosure may be implemented by a dedicated computer comprising a processor programmed to execute one or more functions embodied by a computer program. Alternatively, the apparatus and method described in the present disclosure may be implemented by dedicated hardware logic circuits. Alternatively, the apparatus and method described in the present disclosure may be implemented by one or more dedicated computers configured by a combination of a processor executing a computer program and one or more hardware logic circuits. The computer program may also be stored on a non-transitory computer-readable tangible recording medium as instructions to be executed by a computer.

1. An on-vehicle device configured to be disposed on a vehicle, the on-vehicle device comprising:
an electromagnetic element configured to perform at least one of radiation of electromagnetic wave to an outside of the on-vehicle device or detection of electromagnetic wave from the outside of the on-vehicle device; and
an acoustic sensor configured to detect acoustics generated in the outside of the on-vehicle device, wherein
the acoustic sensor is integrated with the electromagnetic element.

2. The on-vehicle device according to claim 1, further comprising
a housing that houses the electromagnetic element and the acoustic sensor, wherein
the acoustic sensor includes a microphone configured to detect, as the acoustics, vibration of air in an internal space of the housing.

3. The on-vehicle device according to claim 2, wherein
the electromagnetic element is a camera configured to capture an image of the outside of the on-vehicle device, wherein
the housing includes:
a hood configured to block diffusely reflected light entering the on-vehicle device from the outside, the hood having a shape in accordance with an angle of view of the camera such that a width of the internal space gradually increases as a distance between the hood and the camera increases; and
a board housing portion housing a circuit board on which the microphone is mounted, the circuit board being shared by the camera and the acoustic sensor, and
the hood defines a sound guiding hole that fluidly connects the microphone and the internal space.

4. The on-vehicle device according to claim 1, further comprising
a housing fixed to an external structure of the vehicle and housing the electromagnetic element, wherein
the acoustic sensor is supported by an outer wall of the housing that houses the electromagnetic element, and
the acoustic sensor includes a microphone configured to detect vibration of the external structure and is disposed at a position of the outer wall to receive vibration of the external structure.

5. The on-vehicle device according to claim 4, wherein
the microphone is in close contact with the external structure via a viscoelastic body that is disposed between the microphone and the external structure.

6. The on-vehicle device according to claim 4, wherein
the microphone is in close contact with the external structure while a viscoelastic body is disposed between the microphone and the housing.

7. The on-vehicle device according to claim 1, further comprising:
a first housing component housing the electromagnetic element; and
a second housing component housing the acoustic sensor, wherein
the acoustic sensor is integrated with the electromagnetic element by fixing the second housing component to the first housing component.

8. The on-vehicle device according to claim 1, further comprising:
a bracket attached to an external structure of the vehicle;
a first housing component housing the electromagnetic element; and
a second housing component housing the acoustic sensor, wherein
the acoustic sensor is integrated with the electromagnetic element by fixing the first housing component and the second housing component to the bracket.

9. The on-vehicle device according to claim 8, further comprising
a retainer spring pushing the second housing component against the external structure by elasticity.

10. The on-vehicle device according to claim 8, wherein
the bracket defines an opening at a position facing the external structure, and
the on-vehicle device further comprising
a retainer spring pushing the second housing component directly against the external structure through the opening by elasticity.

11. The on-vehicle device according to claim 1, further comprising
a housing that houses the electromagnetic element and the acoustic sensor, wherein
the acoustic sensor includes a microphone configured to detect vibration of air as the acoustics, and
the housing defines a sound guiding hole that fluidly connects the microphone and the outside of the on-vehicle device.

12. The on-vehicle device according to claim 11, wherein
the sound guiding hole fluidly connects the microphone and a surrounding environment of the vehicle as the outside, and
the housing includes a sound-permeable filter disposed to close the sound guiding hole, the sound-permeable filter having a sound permeability and a waterproofness.

13. The on-vehicle device according to claim 11, wherein
the sound guiding hole fluidly connects the microphone and an interior space of the vehicle as the outside.

14. The on-vehicle device according to claim 1, further comprising
a housing that houses the electromagnetic element and the acoustic sensor, wherein
the acoustic sensor includes a microphone configured to detect vibration of air as the acoustics,
the electromagnetic element includes a lens system which includes an exposed lens exposed to a surrounding environment of the vehicle, and a different lens that is different from the exposed lens, and
the housing defines a sound guiding hole fluidly connecting the microphone and a space in the lens system defined between the exposed lens and the different lens.

15. The on-vehicle device according to claim 1, further comprising
a housing that houses the electromagnetic element, wherein the acoustic sensor includes:
a first microphone configured to detect vibration of air as the acoustics; and
a second microphone that is different from the first microphone and configured to detect vibration of air as the acoustics, the first microphone and the second microphone being housed in the housing,
the housing defines:
a first sound guiding hole through which an external sound of the vehicle is guided to the first microphone; and
a second sound guiding hole thorough which an internal sound of the vehicle is guided to the second microphone.

16. The on-vehicle device according to claim 1, further comprising
a housing that houses the electromagnetic element and the acoustic sensor, wherein
the acoustic sensor includes a microphone configured detect vibration of air as the acoustics,
the housing defines:
a first sound guiding hole through which an external sound of the vehicle is guided to the microphone; and
a second sound guiding hole through which an internal sound of the vehicle is guided to the microphone.

17. The on-vehicle device according to claim 1, wherein
the electromagnetic element is electrically connected with an other device in the vehicle by a harness that electrically connects the acoustic sensor with the other device.

18. The on-vehicle device according to claim 1, wherein
the acoustic sensor is configured to detect an analog electrical signal and convert the detected analog signal to a digital signal to generate a sound signal, and
the electromagnetic element communicates with an other device in the vehicle using digital signals through a communication line that is used by the acoustic sensor to communicate with the other device using digital signals.
